(19) United States
(12) Patent Application Publication
(10) Pub. No.: US 2007/0171215 A1
(43) Pub. Date: Jul. 26, 2007

(54) Display device

(75) Inventor: Ik-Sun Song, Suwon-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/546,624

(22) Filed: Oct. 11, 2006

(30) Foreign Application Priority Data
Jan. 24, 2006 (KR) 2006-7396

(51) Int. Cl. G09G 5/00

(52) U.S. Cl. 345/204

(57) ABSTRACT

A display device includes a display panel, a rear case, a printed circuit board (PCB), and a conductive adhesive member. The rear case includes a bottom plate and sidewalls. The bottom plate faces the display panel and the sidewalls are extended from the bottom plate along the display panel. The PCB includes a ground conductive layer and is electrically connected to the display panel. The ground conductive layer is exposed toward the bottom plate. The conductive adhesive member is disposed between the ground conductive layer and the bottom plate and electrically connects them. Accordingly, the PCB and/or its circuit components may be protected from static electricity, which may be discharged through the bottom plate.

### CROSS-REFERENCE TO RELATED APPLICATIONS

This application claims priority to Korean Patent Application No. 2006-7396, filed Jan. 24, 2006, which is incorporated herein by reference in its entirety.

### FIELD OF THE INVENTION

The present invention relates generally to display devices and in particular to display devices, such as liquid crystal displays, and display device techniques for reducing the risk of damage to circuit components of a printed circuit board due to static electricity.

### BACKGROUND OF THE INVENTION

Liquid crystal displays (LCDs) generally include an LCD panel having an array substrate, a counter substrate facing the array substrate, and a liquid crystal layer interposed therebetween, and a driving unit to drive the LCD panel. The array substrate includes gate lines, data lines, and switching elements (e.g., thin-film transistors (TFTs)) electrically connected to the associated gate line and data line. Bonding pads are formed in the array substrate and are connected to signal lines such as the gate lines and data lines.

The driving unit includes gate drivers, data drivers, a timing controller, a voltage generator, and a gamma voltage generator. The timing controller, the voltage generator, and the gamma voltage generator are mounted on a printed circuit board (PCB), while the gate drivers and data drivers are mounted on flexible printed circuit films (e.g., flexible PCBs). The flexible printed circuit films are disposed between the PCB and the array substrate and connected to signal lines through bonding pads.

Steps for fabricating the display panel, such as forming an active layer (i.e. semiconductor layer) or etching a passivation layer, and steps for assembling the LCD, such as forming or removing a protective film to protect the display panel, may generate static electricity. The static electricity flows through metal circuit lines in the display panel or the PCB and results in failures, such as disconnects or shorting of the metal circuit lines. Furthermore, the static electricity may cause electrical damage to circuit components, such as the timing controller. Therefore, there is a need for improved LCD systems and methods directed to reducing potential damage due to static electricity.

### BRIEF SUMMARY OF THE INVENTION

In accordance with one or more embodiments of the present invention described herein, there is provided a display device (e.g., an LCD) that may reduce potential damage to circuit elements of a PCB caused by static electricity and thus may improve circuit reliability. For example in one such embodiment, the display device includes a display panel, a rear case (e.g., a receiving container), a PCB, and a conductive adhesive member. The rear case includes a bottom plate and sidewalls. The bottom plate faces the display panel, with the sidewalls extending from the bottom plate along the edges of the display panel. The PCB is electrically connected to the display panel and includes a ground conductive layer and an insulating layer covering the ground conductive layer, wherein the insulating layer has an opening through which at least a portion of at least a portion of the ground conductive layer is exposed to the bottom plate. The conductive adhesive member is disposed between the ground conductive layer and the rear portion of the bottom plate, to electrically connect the ground conductive layer to the rear case.

In accordance with an embodiment, the PCB further includes a control PCB, a source PCB, and a connecting flexible printed circuit film. The control PCB outputs a control signal to control a timing of a panel-driving signal for the display panel. The source PCB outputs the panel-driving signal to the display panel in response to the control signal. The connecting flexible printed circuit film electrically connects the source PCB to the control PCB.

The source PCB includes a first side and a second side opposite to the first side. In accordance with an embodiment, the connecting flexible printed circuit film is connected to a peripheral portion (e.g., the edge) of the first side and the ground conductive layer is formed on the second side. The bottom surface includes a first protrusion to support the source PCB, and the conductive adhesive member is disposed between the ground conductive layer and the first protrusion. The control PCB includes a connector, with an input of the connecting flexible printed circuit film inserted into the connector.

In accordance with an embodiment, the display device further includes a source flexible printed circuit film. The source flexible printed circuit film electrically connects the source PCB to the display panel. The source PCB includes a driving unit to output panel-driving signals to the display panel. The control PCB includes a timing controller to output control signals to the driving unit.

For example in accordance with an embodiment, the display device further includes a backlight assembly and a mold frame. The backlight assembly provides light to the display panel. The mold frame is combined with the rear case to cover peripheral portions (e.g., the edges) of the backlight assembly and supports the display panel.

In accordance with an embodiment, the ground conductive layer, which is formed on the PCB and is electrically connected to the bottom surface, may reduce the potential for damage to the display device. For example, the PCB, including circuit components and conductive paths on the PCB, may be protected or have a reduced risk of damage due to static electricity generated during the manufacture, assembly, and use of the display device.

A better understanding of the above and many other features and advantages of the systems and methods of the present invention may be obtained from a consideration of the detailed description of the exemplary embodiments herein, particularly if such consideration is made in conjunction with the several views of the appended drawings, wherein like reference numerals are used to identify like elements illustrated in one or more of the figures.

### BRIEF DESCRIPTION OF THE DRAWINGS

FIG. 1 is an exploded perspective view illustrating a display device in accordance with an embodiment of the present invention;

FIG. 2 is a partial cross-sectional view taken along a line I-I′ of the display device of FIG. 1;

FIG. 3 is an exploded perspective view illustrating another display device in accordance with an embodiment of the present invention;

FIG. 4 is a bottom view illustrating the display device of FIG. 3;

FIG. 5 is a partial cross-sectional view taken along a line II-II′ of the display device of FIG. 3; and

FIG. 6 is a partial cross-sectional view illustrating a display device in accordance with an embodiment of the present invention.

### DETAILED DESCRIPTION OF THE INVENTION

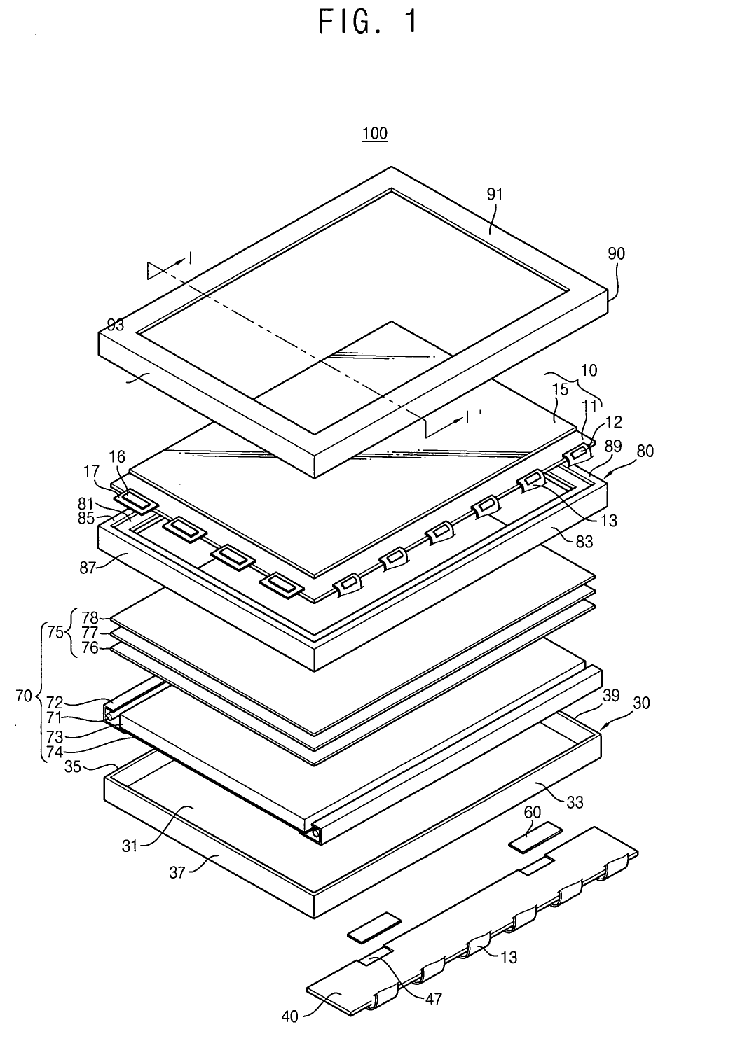

FIG. 1 is an exploded perspective view illustrating a display device 100 for a LCD in accordance with an embodiment of the present invention. The display device 100 includes a display panel 10, a rear case 30, a printed circuit board (PCB) 40, and a conductive adhesive member 60.

The display panel 10 displays images in response to driving signals provided by the PCB 40. The display panel 10 includes a lower substrate 11 (e.g., an array panel), an upper substrate 15 (e.g., a second array panel), and a liquid crystal layer (not shown) interposed therebetween.

Lower substrate 11 includes a plurality of data lines and gate lines, with the data lines and the gate lines defining a plurality of pixels. Each pixel (not shown) includes a switching device (e.g., a thin-film transistor), a pixel electrode electrically connected to the switching device, and a storage capacitor (e.g., a storage common line). The upper substrate 15 includes a common electrode, facing the pixel electrode, and color filters. (not shown, e.g., color filter layers).

The display panel 10 further includes or is connected to one or more source flexible printed circuit films 13 and one or more gate flexible printed circuit films 17 on which data drivers 12 and gate drivers 16 are mounted, respectively. The source flexible printed circuit film 13 is bonded to data pads (not shown) formed in the long side of the lower substrate 11, and electrically connected to the data lines. The gate flexible printed circuit film 17 is bonded to gate pads (not shown) formed in the short side of the lower substrate 11, and electrically connected to the gate lines.

The data drivers 12 output data signals to the data lines and the gate drivers 16 output gate signals to the gate lines. When the gate signal is applied to the switching device, the data signal is transmitted to the pixel electrode through the switching device.

The liquid crystal (LC) layer is interposed between the lower substrate 11 and the upper substrate 15. The display device displays images by applying voltages to the pixel electrodes and the common electrode to generate an electric field in the LC layer, which controls the orientation of the LC molecules in the LC layer to effect the polarization of light passing through the layer.

The rear case 30 (e.g., receiving container) includes a bottom plate 31 and first to fourth sidewalls 33, 35, 37, and 39, respectively. The first sidewall 33 and the second sidewall 35 face each other, and the third sidewall 37 and the fourth sidewall 39 face each other to connect the first sidewall 33 to the second sidewall 35. The bottom plate 31 faces the display panel 10 and the first to fourth sidewalls 33, 35, 37 and 39 are extended from the bottom plate 31 along the four edges of the display panel 10. The rear case 30 may include a metal to protect the display panel 10 from an external impact and prevent an external electromagnetic wave from entering the display panel 10.

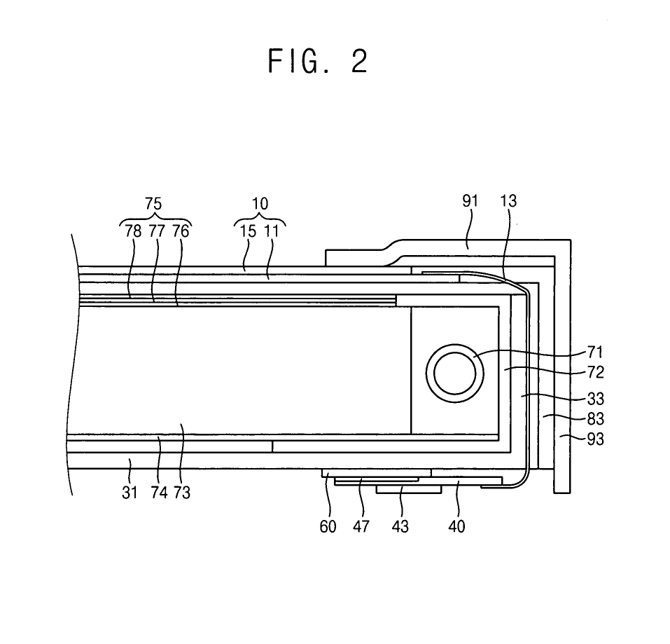

FIG. 2 is a partial cross-sectional view taken along the line I-I′ of the display device of FIG. 1. Referring to FIGS. 1 and 2, the display device further includes a backlight assembly 70 and a mold frame 80.

The backlight assembly 70 provides the display panel 10 with light to display an image, and includes a light source 71, a reflector 72, a light-guiding unit 73, a reflective sheet 74, and an optical sheet 75.

For example in accordance with an embodiment, light source 71 may include two light lamps, one disposed adjacent to the first sidewall 33 and one disposed adjacent to the second sidewall 35. The number and/or the position of the light sources can be adapted for the display device implementation. The reflector 72 covers the light source 71 to reflect the light emitted from the light source 71 toward the light-guiding unit 73. The light-guiding unit 73 is disposed between the bottom plate 31 and the display panel 10 to guide and transmit the light toward the display panel 10. The reflective sheet 74 is disposed between the bottom plate 31 and the light-guiding unit 73 to reflect the light received from the light-guiding unit 73 back to it.

The optical sheet 75 is disposed between the light-guiding unit 73 and the display panel 10 to improve optical characteristics (e.g., adjusts the distribution, direction and intensity) of the light transmitted by the light-guiding unit 73 to the display panel 10. The optical sheet 75 includes a diffuser film 76, to diffuse the light exiting from the light-guiding unit 73, and prism films 77 and 78 (e.g., condensing sheets) to collect the diffused light.

The mold frame 80 includes a first to a fourth frame 83, 85, 87, and 89, respectively, and covers at least a portion of the optical sheet 75 and is combined with the rear case 30. The first to the fourth frames 83, 85, 87, and 89 correspond to and combine with the first to the fourth sidewalls 33, 35, 37, and 39, respectively. A step 81 is formed inside the first to fourth frames 83, 85, 87, and 89, with the display panel 10 disposed on the step 81. The display device 100 further includes a front-case 90 (e.g., a top chassis) to define an effective display region of the display panel 10 and to combine with the mold frame 80.

The PCB 40 outputs control signals to control the data driver 12 and the gate driver 16. The source flexible printed circuit film 13 is bent and disposed between the first sidewall 33 and the first frame 83, and the PCB 40 is disposed on the bottom plate 31 (e.g., a rear surface) opposite to the display panel 10.

Circuit components 43 are mounted on the PCB 40, which includes an insulating board having an insulating layer and a conductive pattern insulated from the exterior by the insulating layer. The conductive pattern is formed by depositing and patterning a conductive layer on the insulating layer. The circuit components 43 are mounted on a rear surface of the insulating board and are electrically connected through the conductive pattern.

The insulating board is electrically connected to the source flexible printed circuit film 13. Thus, the PCB 40 is electrically connected to the data driver 12 through the source flexible printed circuit film 13, and to the gate driver 16 through the source flexible printed circuit film 13 and metal lines formed at a peripheral portion (e.g., on the edge) of the lower substrate 11.

A portion of the insulating layer in the PCB 40 facing the bottom plate 31 is removed to expose at least a portion of the conductive layer and form a ground conductive layer 47. The ground conductive layer 47 provides a path to discharge static electricity generated during the manufacturing of the display panel 10 and/or during the assembling of the display device 100. The insulating layer (not shown) covers the ground conductive layer 47 and the insulating layer has an opening through which at least a portion of at least a portion of the ground conductive layer is exposed.

A conductive adhesive member 60 is disposed between the ground conductive layer 47 and the bottom plate 31 and electrically connects them. For example in accordance with an embodiment, the conductive adhesive member 60 is a conductive, double-sided adhesive tape. Accordingly, static electricity flowing into the PCB 40 (e.g., from the display panel 10 and/or the backlight assembly 70) discharges through the bottom plate 31, and thus reduces the potential damage to circuit components 43 on PCB 40 due to the static electricity.

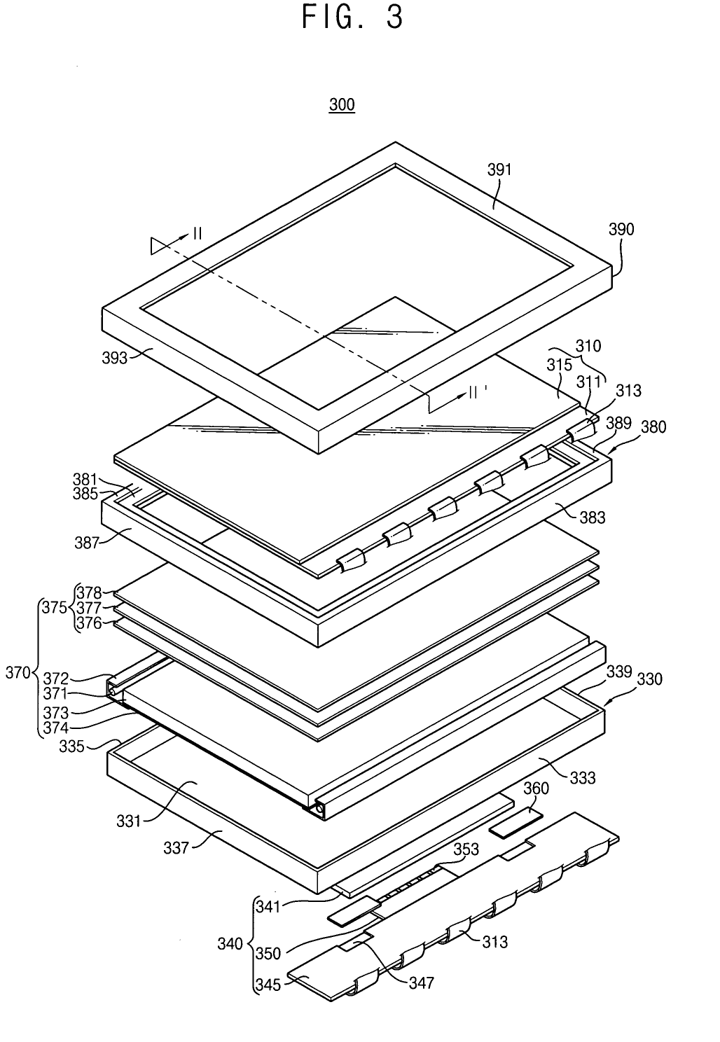

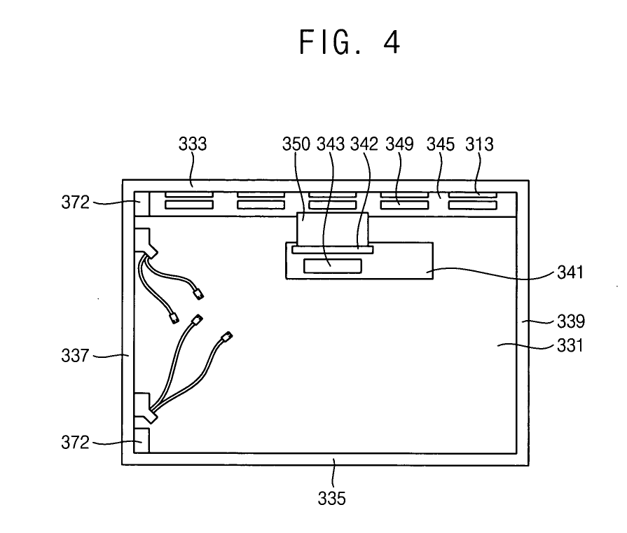

FIG. 3 is an exploded perspective view illustrating another embodiment of a display device in accordance with an embodiment of the present invention. FIG. 4 is a bottom view (e.g., rear plan view) of the display device 300 of FIG. 3. The display device 300 is substantially identical to the display device 100 shown in FIGS. 1 and 2 except for a display panel 310 and a PCB 340.

Referring to FIGS. 3 and 4, the display device 300 includes the display panel 310, a rear case 330 (e.g., a receiving container), PCB 340, a conductive adhesive member 360, a backlight assembly 370, a mold frame 380, and a front-case 390 (e.g., top chassis).

The display panel 310 includes a lower substrate 311, an upper substrate 315, a liquid crystal layer interposed therebetween, and a source flexible printed circuit film 313. The display panel 310 is substantially identical to the display panel 10 of FIGS. 1 and 2 except that gate drivers, gate flexible printed circuit film, and data drivers are removed.

The source flexible printed circuit film 313 electrically and physically connects the display panel 310 to the PCB 340 and is connected to a relatively long side portion of the display panel 310. The PCB 340 is electrically connected to the data lines through the source flexible printed circuit film 313 and to the gate lines through the source flexible printed circuit film 313 and metal lines formed on a relatively short side portion of the lower substrate 311.

For example in accordance with an embodiment, the PCB 340 includes two PCBs, a control PCB 341 and a source PCB 345, which are connected by a connecting flexible printed circuit film 350. The PCB 340 includes a plurality of circuit components, and if at least one circuit component is damaged or defective, the whole PCB 340 may not be usable and should be replaced. Accordingly, as shown in this embodiment, where circuit components are separately mounted on more than one PCB, one PCB may still be used although a circuit component on the other PCB is damaged or defective. signals (e.g., data signals and gate signals) applied to the display panel 310 and includes a connector 342 to electrically connect to the source PCB 345 via the connecting flexible printed circuit film 350. For example, the connector includes an output end portion bonded to the connecting flexible printed circuit film 350 and an input end portion formed at the control PCB 341. Output terminals of the connecting flexible printed circuit film 350 are bonded to the source PCB 345 and input terminals 353 of the connecting flexible printed circuit film 350 are inserted into the connector 342 of the control PCB 341.

The source PCB 345 is electrically connected to the display panel 310 through the source flexible printed circuit film 313. The source PCB 345 provides the driving signals to the display panel 310 through the source flexible printed circuit film 313 in response to the control signals applied to the source PCB 345 through the connecting flexible printed circuit film 350.

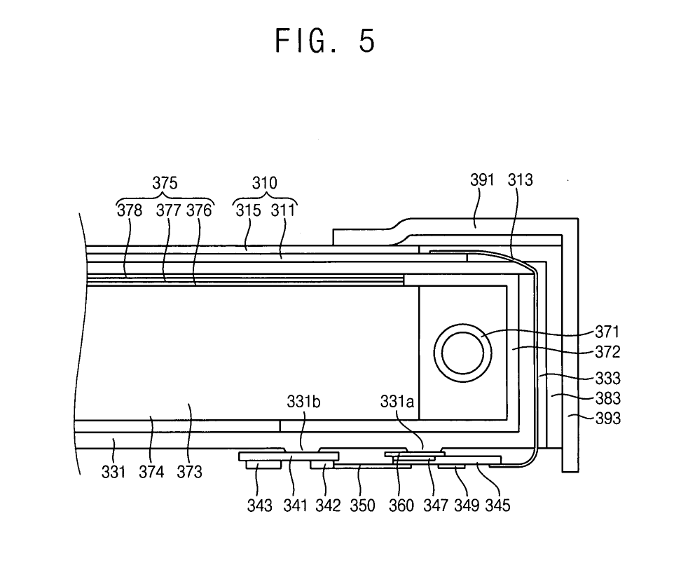

FIG. 5 is a partial cross-sectional view taken along the line II-II′ of the display device of FIG. 3. Referring to FIGS. 4 and 5, the control PCB 341 further includes a timing controller 343, a voltage generator (not shown), and a gamma voltage generator (not shown). The source PCB 345 further includes driving units 349 having gate drivers and data drivers.

The timing controller 343 generates control signals to control the display device 300 based on input signals supplied by an external graphic controller (not shown). The control signals from the timing controller 343 include a first control signal to control the voltage generator, a second control signal to control the gate driver, and a third control signal to control the data driver.

The voltage generator (e.g., a driving voltage generator) outputs digital voltages (DVDD) and analog voltages (AVDD), which drive the data drivers in response to the first control signal, gate on/off voltages (VON, VOFF), and common voltages (Vcom and Vst of a liquid crystal capacitor and a storage capacitor, respectively), which are applied to the display panel 310. The gamma voltage generator generates and outputs reference voltage (Vref) to the data drivers by using the analog driving voltage AVDD.

The gate drivers generate gate signals based on the second control signal by using the gate on/off voltages (Von, Voff) and transmit the gate signals to the display panel 310. The data driver converts digital data signals into analog data signals by using the gamma reference voltage Vref, and provides the analog data signals to the display panel 310.

The control PCB 341 and the source PCB 345 are disposed on the bottom plate 331 (e.g., on a rear surface of the bottom plate 331). A first protrusion 331 a and a second protrusion 331 b are formed on the bottom plate 331 (e.g., on the rear surface) to support the control PCB 341 and the source PCB 345.

The source PCB 345 includes a ground conductive layer 347 exposed toward the bottom plate 331. The ground conductive layer 347 may be formed in a peripheral area (e.g., on the edges) of the source PCB 345 in the area corresponding to the output end portion of the connecting flexible printed circuit film 350. The conductive adhesive member 360 is disposed between the ground conductive layer 347 and the first protrusion 331 a and electrically connects the ground conductive layer 347 to the bottom plate 331.

Static electricity, which may be generated during the manufacturing process of the display panel 310 and/or for during the assembling of the display device 300 and flows into the source PCB 345, is discharged through the bottom plate 331, thereby reducing the damage on the source PCB 345. Furthermore, static electricity, which may be generated during the insertion of the input terminals 353 (in FIG. 3) into the connector 342 formed at the control PCB 341 (in FIG. 4), is discharged through the bottom plate 331, thereby reducing the risk of damage to circuit elements, such as the timing controller 343, the voltage generator, and the gamma voltage generator.

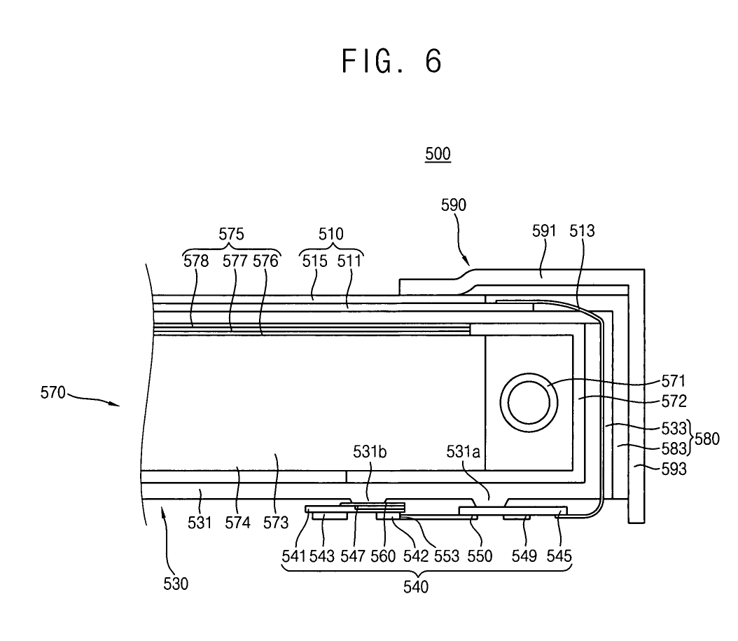

FIG. 6 is a partial cross-sectional view of another embodiment of a display device 500 in accordance with an embodiment of the present invention. The display device 500 includes a display panel 510, a rear case 530 (e.g., a receiving container), a PCB 540, a conductive adhesive member 560, a backlight assembly 570, a mold frame 580, and a front-case 590 (e.g., top chassis). The display device 500 is substantially identical to the display device of FIGS. 3 to 5 except for the location of a ground conductive layer 547 on PCB 540.

The PCB 540 includes a control PCB 541, a source PCB 545, and a connecting flexible printed circuit film 550. The ground conductive layer 547 is formed in a peripheral area (e.g., on the edge) of the control PCB 541 to correspond with the connector 542. The conductive adhesive member 560 is disposed between the ground conductive layer 547 and a second protrusion 531 b to electrically connect the ground conductive layer 547 to the bottom plate 531.

After the control PCB 541 is fixed to the bottom plate 531 by the conductive adhesive member 560, an input end portion 553 of the connecting flexible printed circuit film 550 may be inserted into the connector 542. Accordingly, static electricity, which may be generated during the insertion of the input end portion 553 of the connecting flexible printed circuit film 550 into the connector 542 of the control PCB 541, is discharged into the bottom plate 531 through the ground conductive layer 547 and the conductive adhesive member 560., thereby reducing the risk of damage to the circuit elements, such as the timing controller 543, the voltage generator, and the gamma voltage generator. Alternatively in accordance with another embodiment, the ground conductive layer 547 may be formed on both the source PCB 545 and the control PCB 541.

In accordance with one or more embodiments of the present invention described and illustrated herein, a ground conductive layer of a PCB may be exposed by removing a portion of the insulating layer of the PCB, with the ground conductive layer combined with the bottom plate of the rear case through the conductive adhesive member. Accordingly, static electricity, which may be generated during a process of manufacturing the display panel and/or during a process of assembling the display device and flows into the PCB, may be discharged through the bottom plate to reduce the potential risk of damage to the circuit components mounted on the PCB.

As those of skill in this art will appreciate, many modifications, substitutions and variations can be made in the materials, apparatus, configurations, and methods of the present invention without departing from its spirit and scope. In light of this, the scope of the present invention should not be limited to that of the particular embodiments illustrated and described herein, as they are only exemplary in nature, but instead, should be fully commensurate with that of the claims appended hereafter.

What is claimed is:

1. A display device comprising:
a display panel to display images;
a rear case having a bottom plate facing the display panel and sidewalls extending from the bottom plate along a peripheral portion of the display panel;
a printed circuit board, coupled to the display panel, having a ground conductive layer and an insulating layer covering the ground conductive layer, wherein the insulating layer has an opening through which at least a portion of the ground conductive layer is exposed; and
a conductive adhesive member disposed between an exposed portion of the ground conductive layer and the bottom plate to electrically connect the ground conductive layer to the rear case.

2. The display device of claim 1, wherein the printed circuit board further comprises a source printed circuit board to provide driving signals to the display panel in response to control signals.

3. The display device of claim 2, wherein the source printed circuit board includes a first side and a second side opposite to the first side, and wherein the connecting flexible printed circuit film is connected to a peripheral portion of the first side and the opening, through which the exposed portion of the ground conductive layer is exposed, is formed on the second side.

4. The display device of claim 2, wherein the printed circuit board further comprises a control printed circuit board to provide control signals and a connecting flexible printed circuit film to electrically connect the source printed circuit board to the control printed circuit board.

5. The display device of claim 2, wherein the bottom plate includes a first protrusion to support the source printed circuit board.

6. The display device of claim 5, wherein the conductive adhesive member is disposed between the first protrusion and the exposed portion of the ground conductive layer.

7. The display device of claim 4, wherein the control printed circuit board includes a connector, wherein an input end portion of the connecting flexible printed circuit film is inserted into the connector.

8. The display device of claim 4, wherein the exposed portion of the ground conductive layer is formed on the control printed circuit board.

9. The display device of claim 7, wherein the exposed portion of the ground conductive layer is formed on the control printed circuit board in a peripheral area to correspond to the connector.

10. The display device of claim 8, wherein the bottom plate includes a second protrusion to support the control printed circuit board.

11. The display device of claim 10, wherein the conductive adhesive member is disposed between the exposed portion of the ground conductive layer and the second protrusion.

12. The display device of claim 2, further comprising a source flexible printed circuit film to electrically connect the source printed circuit board to the display panel.

13. The display device of claim 4, wherein the source printed circuit board further includes a driving unit to provide driving signals, and the control printed circuit board further includes a timing controller to provide control signals.

14. The display device of claim 1, further comprising:
a backlight assembly within the rear case to provide light to the display panel; and
a mold frame coupled to the rear case to cover a peripheral portion of the backlight assembly and to support the display panel.

15. A liquid crystal display device comprising:
a display panel, adapted to display images, comprising an array panel, a first panel facing the array panel, and a liquid crystal layer interposed therebetween;
a rear case including a bottom plate facing the display panel and sidewalls extending from the bottom plate along the edges of the display panel;
a printed circuit board connected to the array panel and including a ground conductive layer and an insulating layer covering the ground conductive layer, wherein the insulating layer has an opening through which at least a portion of at least a portion of the ground conductive layer is exposed to the bottom plate;
a conductive adhesive member disposed between the exposed portion of the ground conductive layer and the bottom plate to electrically connect the ground conductive layer to the rear case;
a backlight assembly enclosed in the rear case to provide light to the display panel; and
a mold frame coupled to the rear case to support the display panel.

16. A display device comprising:
means for displaying images;
a rear case having a bottom plate facing the displaying means, wherein the rear case extends from the bottom plate along a peripheral portion of the displaying means;
a printed circuit board, coupled to the displaying means, having a ground conductive layer and an insulating layer covering the ground conductive layer, wherein the insulating layer has an opening through which at least a portion of at least a portion of the ground conductive layer is exposed to the bottom plate;
means for electrically connecting the ground conductive layer to the rear case means for providing light to the displaying means; and
means for providing signals to the displaying means.

17. The display device of claim 16, further comprising means for supporting the printed circuit board, wherein at least a portion of the supporting means is electrically coupled to the ground conductive layer via the electrically connecting means.
